(19) United States
(12) Patent Application Publication
(10) Pub. No.: US 2003/0205001 A1
(43) Pub. Date: Nov. 6, 2003

(54) Fastened door gap cover and technique for covering the gap between open door and door frame on hinge side of door

(76) Inventors: Wendy Christman Williams, Charlotte, NC (US); Daniela Maria Gariglio, Charlotte, NC (US)

Correspondence Address: WENDY WILLIAMS, 1110 BEVIS DRIVE, CHARLOTTE, NC, 28209, US

(21) Appl. No.: 10/429,808

(22) Filed: May 5, 2003

Related U.S. Application Data
(60) Provisional application No. 60/377,367, filed on May 3, 2002.
(60) Provisional application No. 60/418,945, filed on Oct. 16, 2002.

(51) Int. Cl. E05D 11/00

(52) U.S. Cl. 49/383

(57) ABSTRACT

A fastened door gap cover comprised of an elongated flexible one or multiple piece fixed cover that is connected to door frame and multiple rigid fastener variations for union with door, whereas the fastened connection results in eliminating the gap between the hinge edge of a door and the door frame thus prohibiting objects to be inserted during the opening and closing of the door whether it be sited in an existing or new construction door. The fastened door gap cover device is easy to install, would not inhibit normal door operation and can be made of various materials including but not limited to plastics, rubber, metals or wood and would preferably be a material capable of being either rolled, cut or folded to fit a small size package

### CROSS-REFERENCE TO RELATED APPLICATIONS

Provisional Patent Application Nos. 60/377,367 and 60/418,945 filed by Wendy Williams and Daniela Gariglio, dated May 3, 2002 and Oct. 16, 2002 respectively.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention generally relates to safety guards or covers for preventing body parts or objects from being crushed in door gap and further relates to the methods of covering such gap. There are many prior inventions that pertain to devices that will prevent the insertion of body parts in the open space or gap between the door frame and the hinge side of the door since adults and other children can unknowingly close doors on fingers, pet tails and other objects and cause serious injury due to the pressure force that is introduced when the door closes. Children are particularly at risk because they explore their environments with their hands and their fingers could become hurt. The patents disclosed herein all attempt to solve this dilemma but are different in their functioning concept and experience one or more disadvantages.

### U.S. PATENT DOCUMENTS—REFERENCES CITED

| | | |
|---|---|---|
| 5,001,862 | March 1991 | Albenda |
| 474,633 | May 1892 | Glazier |
| 6,141.909 | Nov. 7, 2000 | Hanson |
| 1,444,398 | February 1923 | Sheppard |
| 2,641,792 | Jan. 17, 1950 | Peeler Hinge |
| 5,509,235 | April 1996 | Chander |
| 2002,0046501, | Apr. 25, 2002 | Webb, Stephen |
| 6,497,073 | December 2002 | Webb |
| 613,592 | November 1898 | Nagley |
| 2,694,234 | Jun. 26, 1953 | Robi |
| 4,040,142 | Aug. 9, 1997 | Ippolito |
| 5,092,077 | Mar. 3, 1992 | Teinturier Milgram |
| 5,419,084 | May 30, 1995 | Sankey |
| 1,444,994 | February 1923 | White |
| 4,344,253 | Aug. 17, 1982 | Stiles |
| 6,134,839 | October 2000 | Johansson |
| 4,878,267 | November 1989 | Roach |
| 2,681,480 | Jun. 3, 1953 | Dixon, |
| 2,995,785 | Feb. 28, 1958 | Hallenbeck |
| 5,359,812 | Nov. 1, 1994 | Mayfield |
| 5,220,708 | Jun. 22, 1993 | Lucas |
| 4,290,233 | September 1981 | Hubbard |
| 5,765,311 | Jun. 16, 1998 | Kapler |
| 1,258,856 | March 1918 | Beaudette |
| 6,434,888 | Aug. 20, 2002 | Shaw |

### FOREIGN PATENT DOCUMENTS—REFERENCES CITED

| | | |
|---|---|---|
| Greet Britain | November 1989 | Class 49/383 |
| France 2,664,936 | January 1992 | Class 49/383 |
| Germany 3,435,615 | April 1995 | Class 49/383 |

U.S. Pat. No. 5,001,862 issued to Albenda dated March 1991 portrays a fixed cover guard on both vertical edges to the door and jamb in which the cover guard extends beyond the door jamb and when it is in a closed position could be damaged upon entry.

U.S. Pat. No. 2002,0,046,501 issued to Stephen Webb dated April 25, shows a guard in which the cover would fold and rest against the door. This method covers the door gap adequately with a vertical removable edge however due to the extra material and style of design would be more expensive to manufacture.

U.S. Pat. No. 4,040,142 issued to Ippolito dated Aug. 9, 1997 shows 4 parallel panels that fold, in which two are attached to the outside of door and door frame and two fold over each other when the door closes. The patent also refers to the dangers door gaps present to children.

U.S. Pat. No. 5,509,235 issued to Chandler dated April 1996 uses a stopper on the hinge side which has to be removed in order to close the door, therefore limiting ease of use.

U.S. Pat. No. 6,434,888 issued to Shaw dated Aug. 20, 2002 relates to a device designed to cover the gap opening. This plate device does not adhere to the door with a fastener, consequently allowing the plate to be lifted and the possible entry of an object. This device plate is also a rigid material which would not allow for door openings greater than 90 or 110 degrees unless fastened by some means.

### BRIEF SUMMARY OF THE INVENTION

This invention pertains to a safety device that covers the open space or gap between a door and its jamb frame on the hinge side of the door; preventing body parts including but not limited to fingers, hands, toes or pet tails from being inserted in this opening and from being unwillingly pinched or hurt. The invention further pertains to methods of covering the open space between a door and its frame or door jamb on the hinge side of the door and methods of attaching the devices to existing doors and new construction doors. The fastened door gap cover device is easy to install, allows for normal door operation and can be made of various materials including but not limited to plastics, rubber, metals or wood, and preferably be a material capable of being rolled, cut or folded to fit a small size package.

### BRIEF DESCRIPTION OF THE SEVERAL VIEWS OF THE DRAWING

For a better comprehension of this invention we are presenting the following diagrams whereas the detailed descriptions will depict the design and use of the several fastened door gap cover options.

FIG. 1 shows front view of door gap cover and upper edge view for three hinge variations of door gap cover with a front view strip fastener.

FIG. 1A shows bird eye view of the strip fastened door gap cover with door in closed position.

FIG. 1B shows bird eye view of the strip fastened door gap cover with door in open position

FIG. 1C shows schematic front view of the strip fastened door gap cover with door in closed position.

FIG. 1D shows schematic front view of the strip fastened door gap cover with door in open position.

FIG. 2 shows front view of slotted door gap cover with upper edge view for three hinge variations of slotted door gap cover and side view for two options of fastener.

FIG. 2A shows bird eye view of fastened slotted door gap cover with door in closed position.

FIG. 2B shows bird eye view of fastened slotted door gap cover with door in open position.

FIG. 2C shows schematic front view of the fastened slotted door gap cover with door in closed position.

FIG. 2D shows schematic front view of the fastened slotted door gap cover with door in open position.

FIG. 2E shows front view of a modular notched fastened door gap cover incorporating a male/female notch design for multiple piece alignment of various fastened door gap covers.

FIG. 2F shows schematic view of modular notched fastened door gap cover being demonstrated on the fastened slotted door gap cover with door in open position.

FIG. 3 shows front view of sliding door gap cover with bird eye view for three hinge variations of sliding door gap cover and a side view of slide guide male/female process for fastener and sliding door gap cover.

FIG. 3A shows bird eye view of fastened sliding door gap cover with door in closed position.

FIG. 3B shows bird eye view of fastened sliding door gap cover with door in open position.

FIG. 3C shows schematic front view of fastened sliding door gap cover with door in closed position.

FIG. 3D shows schematic front view of fastened sliding door gap cover with door in open position.

FIG. 4 shows front view of a new construction inserted door gap cover with bird eye view for three hinge variations of inserted cover and front view of stop gap frame for door.

FIG. 4A shows bird eye view of fastened new construction inserted door gap cover with door in closed position.

FIG. 4B shows bird eye view of fastened new construction inserted door gap cover with door in open position.

FIG. 4C shows bird eye view of fastened new construction inserted door gap cover with door in closed position where attachment of hinge side of cover is beneath door jamb.

FIG. 4D shows bird eye view of fastened new construction inserted door gap cover with door in open position where attachment of hinge side of cover is beneath door jamb.

FIG. 4E shows schematic front view of fastened new construction inserted door gap cover with door in closed position.

FIG. 4F shows schematic front view of fastened new construction inserted door gap cover with door in open position.

FIG. 5 shows front view and bird eye view of inserted roll door gap cover and a front view of stop gap frame for door.

FIG. 5A shows bird eye view of fastened new construction inserted roll door gap cover with door in closed position.

FIG. 5B shows bird eye view of fastened new construction inserted roll door gap cover with door in open position.

FIG. 5C shows schematic front view of new construction inserted door gap cover with door in closed position.

FIG. 5D shows schematic front view of new construction inserted door gap cover with door in open position.

FIG. 6 shows front view of single sided guide fastener in two variations.

FIG. 6A shows front view of double sided guide fastener in two variations.

### DRAWING REFERENCE NUMERALS

| | |
|---|---|
| #1 | Strip fastened cover |
| #2 | Cover hinge line |
| #2a | Hinge line variation with dual sided indentation |
| #2b | Hinge line variation with single sided indentation |
| #2c | Hinge line variation with supported dual sided indentation |
| #3 | Cover fold line |
| #4 | Strip fastener |
| #5 | Screw holes |
| #6 | Screw |
| #7 | Door |
| #8 | Jamb |
| #9 | Door hinge |
| #10 | Slotted cover |
| #11 | Slots |
| #12 | Slotted cover fastener screw |
| #12a | Slotted cover fastener with base support |
| #13 | Sliding cover |
| #14 | Sliding cover protrusion male fastener |
| #15 | Sliding cover channel female fastener |
| #16 | New constructioh inserted cover |
| #17 | Stop gap frame |
| #18 | Cover edge stopper |
| #19 | Roll cover |
| #20 | Roll cover housing |
| #21 | Single sided guide fastener |
| #21a | Single sided guide fastener variation |
| #22 | Cover with male notch |
| #23 | Cover with female notch |
| #24 | Double sided guide fastener |
| #24a | Double sided guide fastener variation |
| #25 | Sliding edge line |
| #26 | Jamb edge |
| #27 | Notched modular fastened door gap cover |

### DETAILED DESCRIPTION OF THE INVENTION

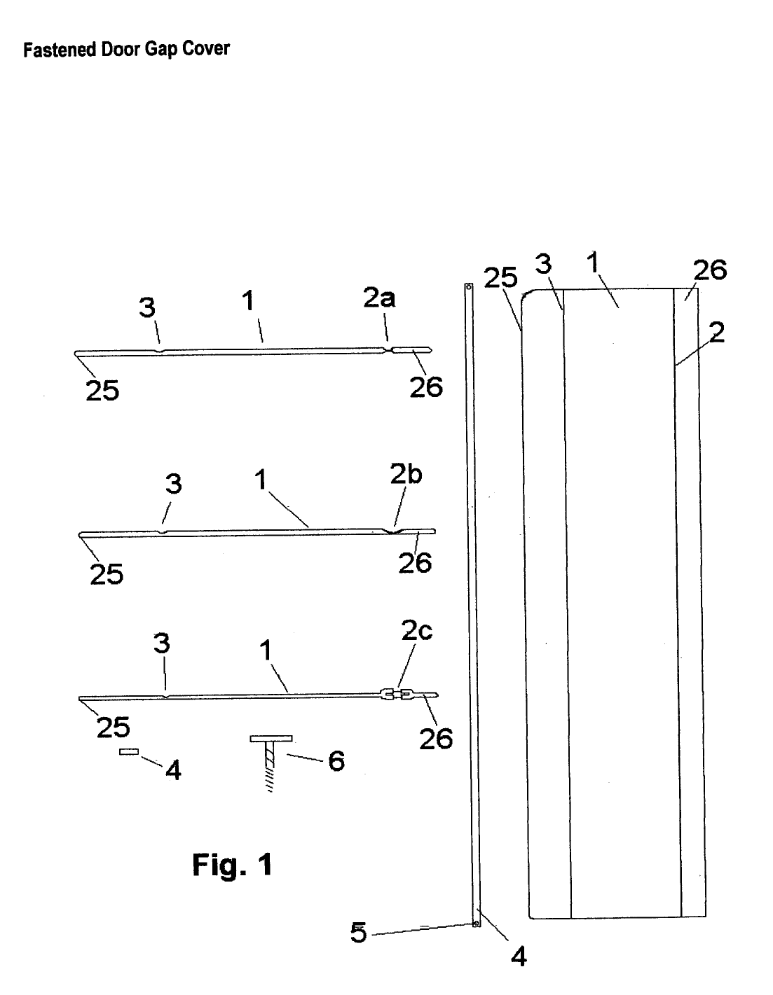

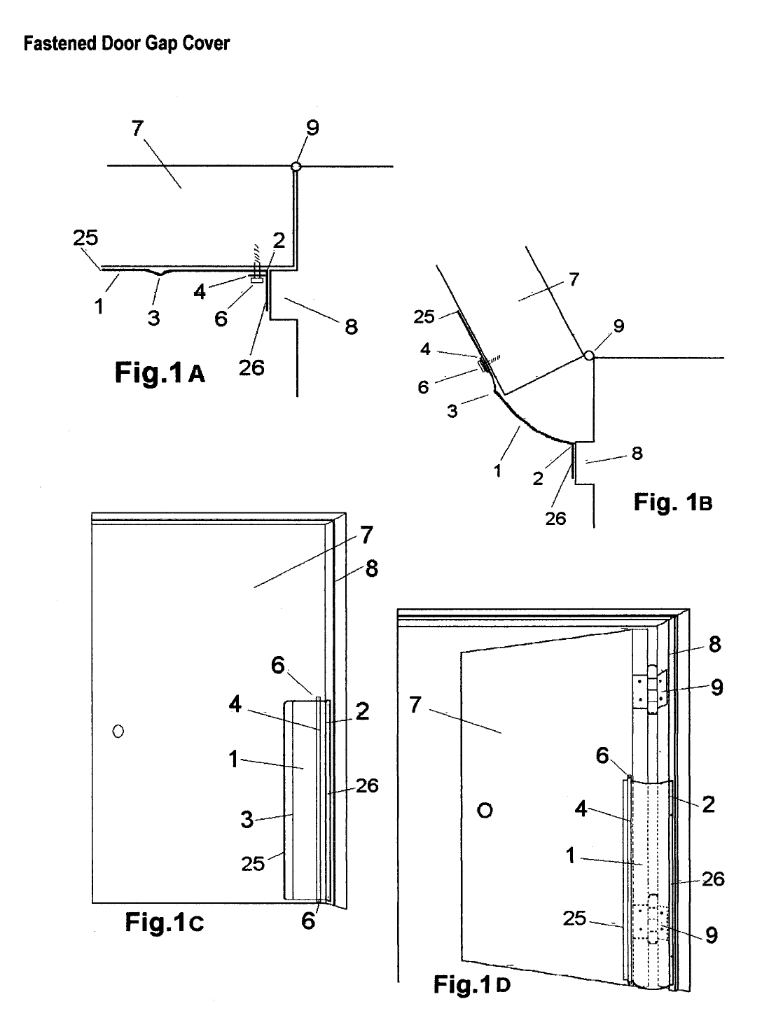

FIG. 1 shows all the parts that comprise a strip fastened option of a fastened door gap cover. It shows a front perspective of the fastened door gap cover 1 and three upper edge views of alternative strip fastened gap cover hinge variations 2a, 2b, 2c for the preferred embodiment of the strip fastened door gap cover 1, together with a front view and an upper edge view of the strip fastener 4 for the strip fastened door gap cover 1.

The strip fastened door gap cover 1 is one single elongated piece made with flexible material such as, but not limited to, flexible plastic of any color suitable to the door design including transparent. It has one vertical hinge line 2 and one vertical fold line 3. The sliding edge line 25 preferably has rounded corners for safety and allows for a smoother slide process while the jamb edge 26 of cover will be attached to the door jamb 8 or to the door frame by using one or more of the following: tape, double face tape, Velcro, permanent adhesion, glue, screw, nails or any other bonding system. The upper edge views of the strip fastener door gap cover 1 show three different possible variations of the hinge line 2. The first variation being a dual sided indentation 2a on front and back of strip fastener door gap cover 1, the second variation being a single sided indentation 2b in the strip fastened door gap cover 1 which can be on the front or back of strip fastened door gap cover 1 and the third variation being a supported dual sided indented flexible material 2c preferably molded as an integrated part of the fastened door gap cover 1 to avoid assembling requirements. The fold line 3 is a single indentation on the front or back of the strip fastened door gap cover 1. More than one fold line 3 can be used.

The strip fastener 4 is a narrow elongated strip of rigid material such as but not limited to a rigid plastic of any color suitable to the door design including transparent, whereas the length of the strip fastener 4 extends beyond the top and bottom edge of the fastened door gap cover 1. The strip fastener 4 has a hole 5 positioned on its top and bottom to house the screws 6 that will fasten the strip fastener 4 to the door 7. A height of about 4 feet or 132 centimeters would be preferable for the strip fastened door gap cover 1 as it would cover that part of the door gap that children can reach. For most residential doors the strip fastened door gap cover 1 should be preferably about 4 and ¼ inches or 11 centimeters wide from the hinge line 2 to the sliding edge line 25 and it should have a jamb edge 26 preferably about ¾ inch or 1.5 centimeters wide. For most commercial doors the strip fastened door gap cover 1 should be preferably about 5 and ½ inches or 14 centimeters wide from the hinge line 2 to the sliding edge line 25 and it should have a jamb edge 26 preferably about 1 inch or 2.5 centimeters wide. The above mentioned dimensions would be suitable for most doors opening up to 110 degree angle. For special installations where the door opens to more than 110 degree angle, a wider strip fastened door gap cover would be required accordingly.

FIG. 1A shows a bird eye view of the strip fastened door gap cover 1 with the jamb edge 26 attached to the door jamb 8 while the door 7 is in a closed position. The strip fastener 4 is attached to the door 7 by means of a screw 6 and it holds the strip fastened door gap cover 1 against the door 7.

FIG. 1B shows a bird eye view of the strip fastened door gap cover 1 with the jamb edge 26 attached to the door jamb 8 while the door 7 is in an open position. The strip fastener 4 is attached to the door 7 by means of a screw 6 allowing the strip fastened door cover 1 to slide and cover the gap while at the same time holding it against the door 7. The fold line 3 allows the strip fastened door gap cover 1 to be slightly folded, thus creating a vertical line of rigidity, that together with the vertical line of rigidity created by the hinge line 2 permits the use of more flexible, lighter materials.

FIG. 1C is a schematic front view of the entire strip fastened door gap cover 1 with its jamb edge 26 installed on the door jamb 8 while the door 7 is in a closed position. The strip fastener 4 is attached to the door 7 by means of two screws 6 or other suitable materials and it holds the strip fastened door cover 1 against the door 7.

FIG. 1D is a schematic front view of the entire strip fastened door gap cover 1 with its jamb edge 26 installed on the door jamb 8 while the door 7 is in an open position. The strip fastener 4 is attached to the door 7 by mean of two screws 6 or other suitable materials allowing the strip fastened door cover 1 to slide and cover the gap while at the same time holding it against the door 7. The fold line 3 allows the strip fastened door cover 1 to be slightly folded, thus creating a vertical line of rigidity that, together with the vertical line of rigidity created by the fastener permits the use of light materials.

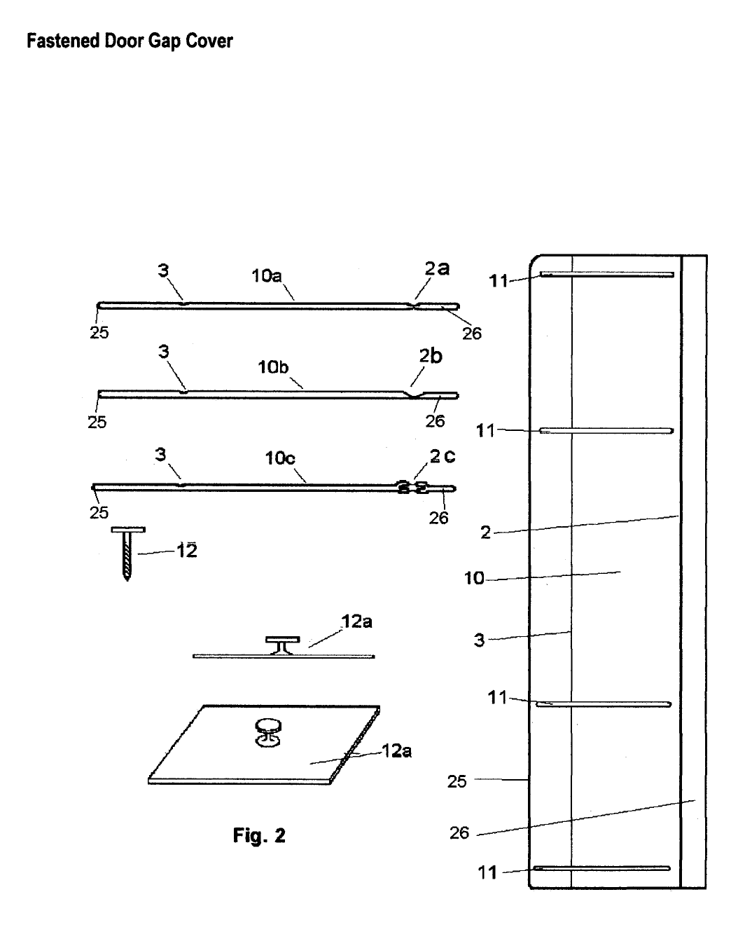

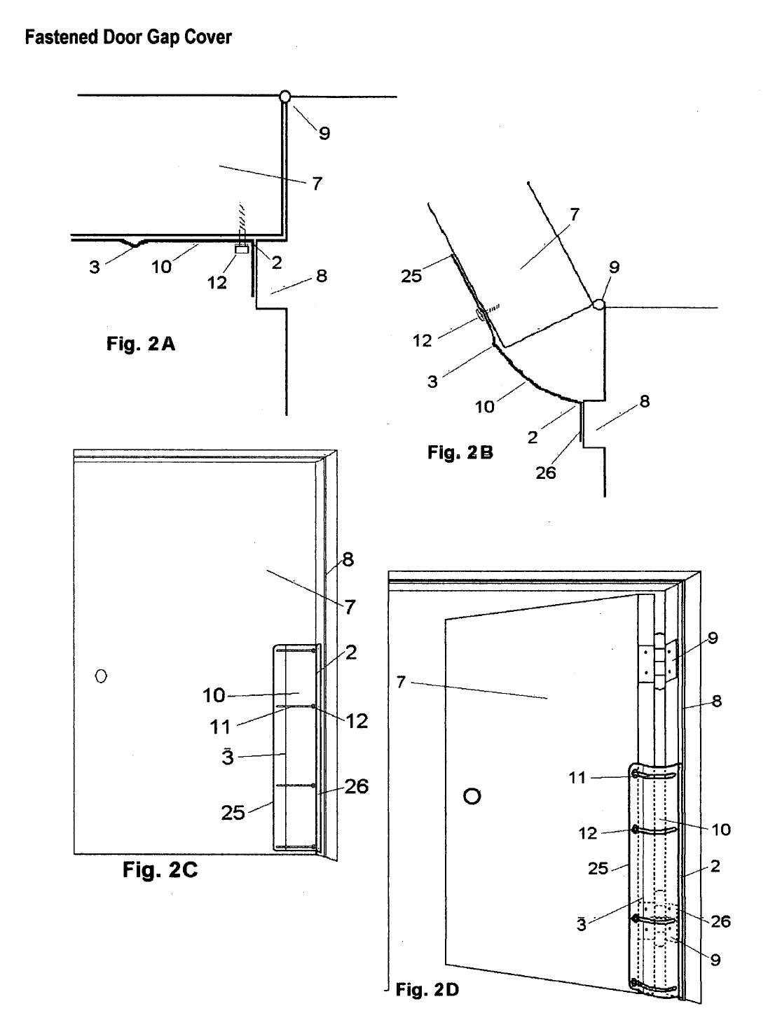

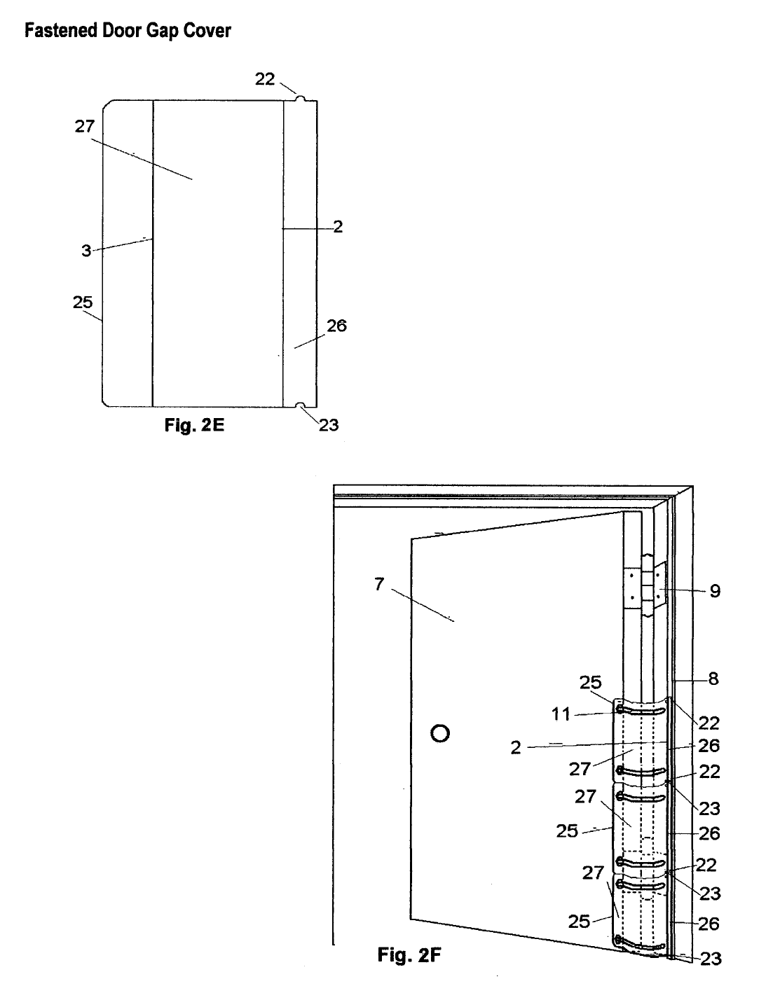

FIG. 2 shows all the parts that comprise the slot fastened variation of the fastened door gap cover. It shows a front perspective view of the slotted fastened door cover 10 and three upper edge views of the alternative slot fastened door gap cover hinge variations 2a, 2b, 2c of the preferred embodiment of the slot fastened door gap cover 10 together with a two variations for the slot fastener 12, 12a, for the slot fastened door gap cover 10. The slot fastened door gap cover 10 is one single elongated piece made with flexible material such as, but not limited to, flexible plastic of any color suitable to the door design, said colors including transparent. It has one vertical hinge line 2, one vertical fold line 3 and preferably four horizontal slots 11. The sliding edge line 25 preferably has rounded corners for safety and allows for a smoother slide process. The jamb edge 26 will be attached to the door jamb 8 or to the door frame by using one or more of the following: tape, double face tape, Velcro, permanent adhesion, glue, screw nails or any other bonding system. The upper edge views of the slot fastened door gap cover 10 show three different possible variations for the hinge line 2. The first variation being a dual sided indentation 2a on front and back of slot fastened door gap cover 10 and the second variation being a single sided indentation 2b in the slot fastened door cover 10 which can be on the front or back of slot fastened door gap cover 10 and the third variation being a supported dual sided indented flexible material 2c preferably molded as an integrated part of the fastened door gap cover 10 to avoid assembling requirements. The fold line 3 is a single indentation on the front or back of the slots fastened door gap cover 10. More than one fold line 2 can be used. The slot fastener 12 is as simple as a screw, but not limited to whereas the body or shank is thinner than the head of the screw and the head of fastener 12 is wider than the slots 11 in the fastened door gap cover 10. Should it not be possible, for any reason to insert a screw, 12 in the door 7, a slot fastener with a large base 12a should be used, whereas a fastener base will be attached to the door 7 by using one or more of the following: tape, double face tape, Velcro, permanent adhesion, glue, or any other bonding system and the fastener will be joined by means of a screw or bolt but not limited to, thus eliminating the need to penetrate the door 7 to hold the fastener 12. A height of about 4 feet or 132 centimeters would be preferred for the slot fastened door gap cover 10 as it would cover that part of the door gap that children can reach. For most residential doors the slot fastened door gap cover 10 should be preferably about 4 and ¼ inches or 11 centimeters wide from the hinge line 2 to the sliding edge line 25 and it should have a jamb edge 26 preferably about ¾ inch or 1.5 centimeters wide. The slots 11 should be preferably about 3 and ¾ inches or 10 centimeters wide, 3 mm in height, centrally positioned between the hinge line 2 and the sliding edge line 25 and evenly distributed through the height of the slot fastened door gap cover 10. For most commercial doors the slot fastened door gap cover 10 should be preferably about 5 and ½ inches or 14 centimeters wide from the hinge line 2 to the sliding edge line 25 and it should have a jamb edge 26 preferably about 1 inches or 2.5 centimeters wide. The slots 11 should be preferably about 4 and ¾ inches or 13 centimeters wide, 3 mm height, centrally positioned between the hinge line 2 and the sliding edge line 25 and evenly distributed through the height of the slot fastened door gap cover 10. The above mentioned dimensions would be suitable for most doors opening up to 110 degrees angle. For special installations where the door is more than 110 degree angle, a wider slot fastened door gap cover 10 would be required accordingly.

FIG. 2A shows a bird eye view of the slot fastened door gap cover 10 with the jamb edge 26 attached to the door jamb 8 while the door 7 is in a closed position. The slot fastener 12 is screwed to the door 7 and holds the slot fastened door cover 10 against the door 7.

FIG. 2B shows a bird eye view of the slot fastened door gap cover 10 with the jamb edge 26 attached to the door jamb 8 while the door 7 is in an open position. The slot fastener 12 is screwed to the door 7, letting the slot fastened door cover 10 to slide and cover the gap while holding it against the door 7. The fold line 3 allows the slot fastened door cover 1 to be slightly folded, thus creating a vertical line of rigidity, that together with the vertical line of rigidity created by the hinge line 2 permits the use of more flexible, lighter materials.

FIG. 2C is a schematic front view of the entire slot fastened door gap cover 10 with its jamb edge 26 installed on the door jamb 8 while the door 7 is in a closed position. The slot fasteners 12 are screwed to the door 7 and hold the slot fastened door cover 10 against the door 7.

FIG. 2D is a schematic front view of the entire slot fastened door gap cover 10 with its jamb edge 26 installed on the door jamb 8 while the door 7 is in an open position. The slot fasteners 12 are screwed to the door 7, allowing the slot fastened door cover 10 to slide and cover the gap while at the same time holding it against the door 7. The fold line 3 allows the slot fastened door cover 1 to be slightly folded, thus creating a vertical line of rigidity that permits the use of light materials.

FIG. 2E shows a front view of a notched modular fastened door gap cover 27, which is one single elongated piece of a flexible material such as, but not limited to, flexible plastic of any color suitable to the door design, said colors including transparent. It has one vertical hinge line 2a, 2b, 2c and one vertical fold line 3. The sliding edge line 25 preferably has rounded corners for safety and allows for a smoother slide process. The jamb edge 26 has a male notch 22 on its top and female notch 23 at the bottom of modular notched fastened door gap cover 27. The jamb edge 26 is attached to the door jamb 8 or to the door frame by using one or more of the following: tape, double face tape, Velcro, permanent adhesion, glue, screw nails or any other bonding system. The notches 22 and 23 guarantee the vertical and horizontal alignment of multiple notched modular fastened door gap covers to be linked, one on top of the other creating the function of increasing and accommodating the height desired for the fastened door gap cover. The manufactured product may allow for incorporating said cover and fastener options independently or collectively

FIG. 2F shows a schematic view of how the modular notched fastened door gap cover 27 can be incorporated for use with the slot fastened door gap cover 10. This view is a sample view demonstrating how the male notch 22 and female notch work in conjunction with slot fastened door gap cover and create increased height coverage as modular notched fastened door gap covers 27 are added and linked. The modular notched fastened door gap cover 27 is preferably twelve to eighteen inches in height and may be adjusted to the requirements needed. The modular notched fastened door gap cover 27 and its concept of being able to be adapted in design to work on any fastened door gap cover and is not limited to the slot fastened design as shown.

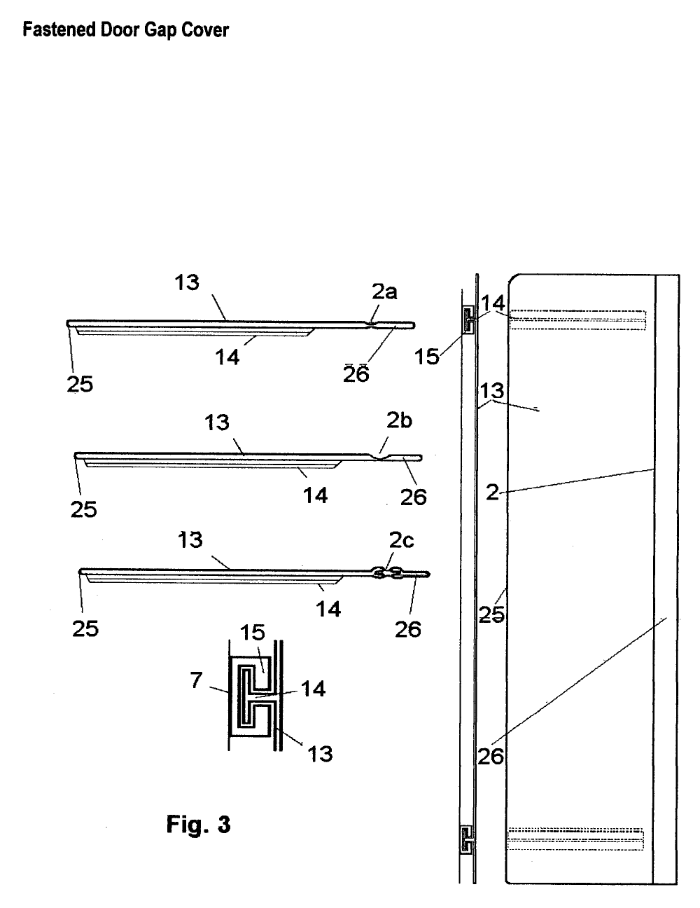

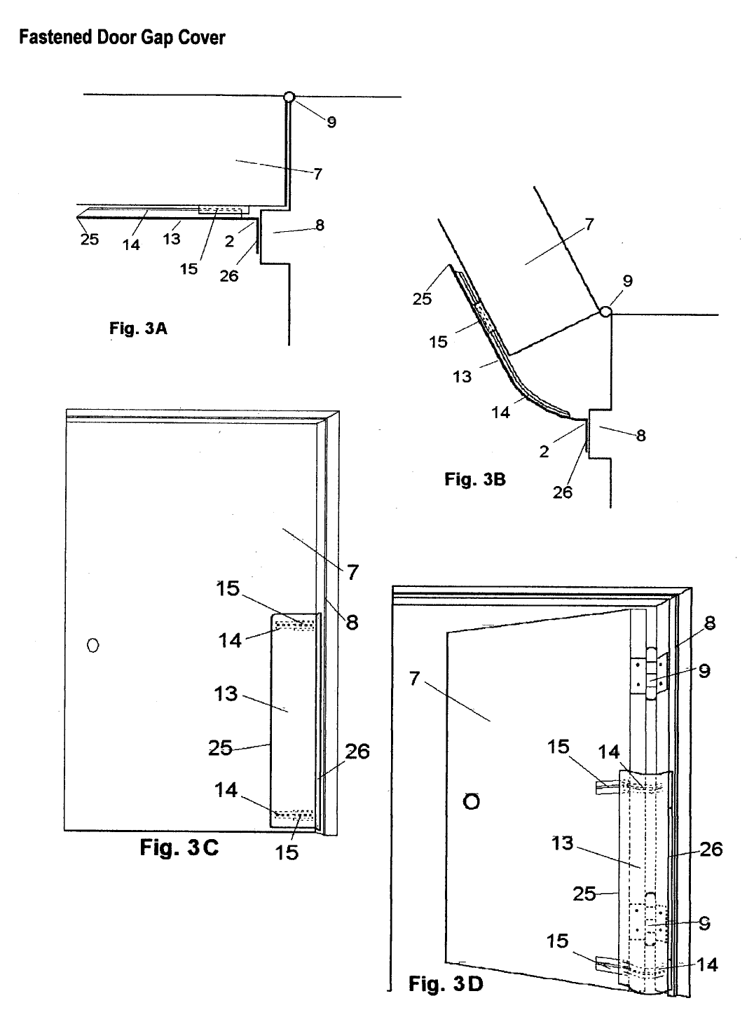

FIG. 3 shows all the parts that comprise the slide fastened variation of the fastened door gap cover. It shows a front perspective and a side perspective of the slide fastened door gap cover 13 and three possible upper edge hinge variations 2a, 2b, 2c, of the preferred embodiment of the slide fastened door gap cover 13, together with a side view of the combination protrusion male slide fastener 14 and channel female slide fastener 15, where the protrusion male slide fastener 14 is attached to the slide fastened cover 13 while the channel female slide fastener 15 is attached to the door 7. The slide fastened door gap cover 13 is one single elongated piece made with flexible material such as, but not limited to, flexible plastic of any color suitable to the door design, said colors including transparent. It has one vertical hinge line 2 and two or more horizontal channel female slide fasteners 15 positioned near the top and bottom rear side of the slide fastened door gap cover 13 between the hinge line 2 and the sliding edge line 25. The sliding edge line 25 preferably has rounded corners for safety and allows for a smoother slide process. The jamb edge 26 will be attached to the door jamb 8 or to the door frame by using one or more of the following: tape, double face tape, Velcro, permanent adhesion, glue, screw nails or any other bonding system. The upper edge views of the slide fastened door gap cover 13 show three different possible variations of the hinge line 2. The first variation being a dual sided indentation 2a on front and back of the slide fastened door gap cover 13, the second variation being a single sided indentation 2b in the strip fastened door gap cover 13 which can be on the front or back of slide fastened door gap cover 13 and the third variation being a supported dual sided indented flexible material 2c preferably molded as an integrated part of the slide fastened door gap cover 13 to avoid assembling requirements. The slide fastener is comprised of two parts, a protrusion male slide fastener 14 and a female slide fastener 15. The male slide fastener 14 is integral part of the slide fastened door gap cover, while the channel female slide fastener 15 will be attached to the door 7 by using one or more of the following: tape, double face tape, Velcro, permanent adhesion, glue, nails, screws or any other bonding system. A height of about 4 feet or 120 centimeters would be most suitable for the slide fastened door gap cover 13 as it would cover that part of the door gap that children can reach. For most residential doors the slide fastened door gap cover 13 should be preferably about 4 and ¼ inches or 11 centimeters wide from the hinge line 2 to the sliding edge line 25 and it should have a jamb edge 26 preferably about ¾ inch or 1.5 centimeters wide. For most commercial doors the slide fastened door gap cover 13 should be preferably about 5 and ½ inches or 14 centimeters wide from the hinge line 2 to the sliding edge line 25 and it should have a jamb edge 26 preferably about 1 inch or 2.5 centimeters wide. The above mentioned dimensions would be suitable for most doors opening up to 110 degree angle. For special installations where the door opens to more than a 110 degree angle, a wider slide fastened door gap cover would be required accordingly.

FIG. 3A shows a bird eye view of the slide fastened door gap cover 13 with the jamb edge 26 attached to the door jamb 8 while the door 7 is in a closed position. The channel female slide fastener 15 is attached to the door 7 and holds the protrusion male slide fastener 14 and consequently the slide fastened door cover 13 against the door 7.

FIG. 3B shows a bird eye view of the slide fastened door gap cover 13 with the jamb edge 26 attached to the door jamb 8 while the door 7 is in an open position. The channel female slide fastener 15 is attached to the door 7 and allows the protrusion male slide fastener 14 and consequently the slide fastened door cover 13 to slide and cover the gap while at the same time hold them against the door 7.

FIG. 3C is a schematic front view of the entire slide fastened door gap cover 13 with its jamb edge 26 installed on the door jamb 8 while the door 7 is in a closed position. The channel female slide fasteners 15 are attached to the door 7 and they hold the protrusion male slide fasteners 14 and consequently the slide fastened door gap cover 13 against the door 7.

FIG. 3D is a schematic front view of the entire slide fastened door gap cover 13 with its jamb edge 26 installed on the door jamb 8 while the door 7 is in an open position. The channel female slide fasteners 15 are attached to the door 7 and allow the protrusion male slide fasteners 14 and consequently the slide fastened door cover 13 to slide and cover the gap while at the same time they hold them against the door 7.

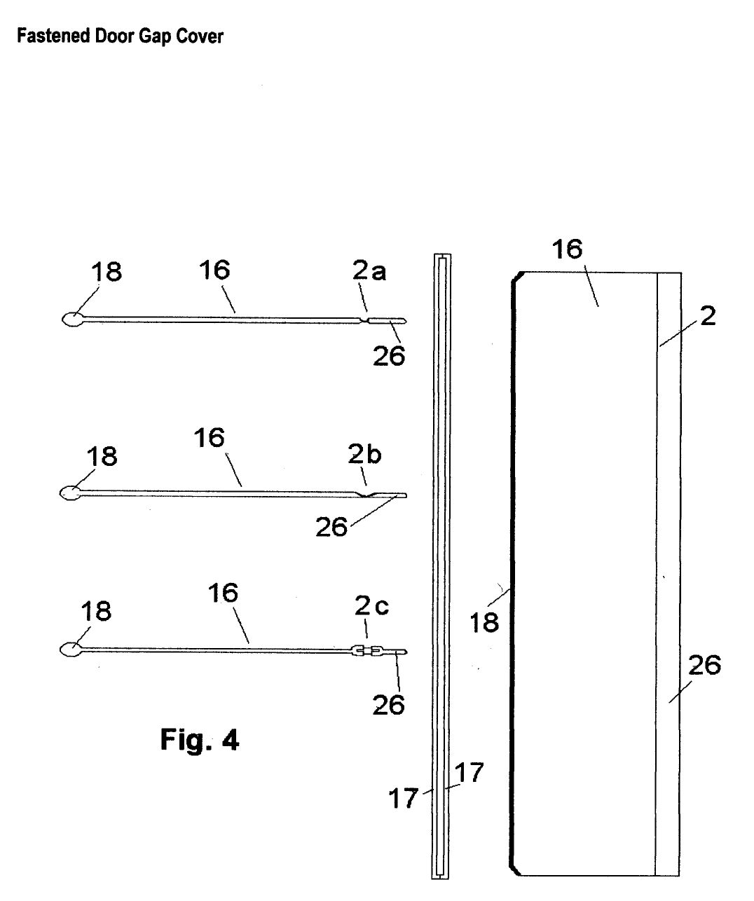

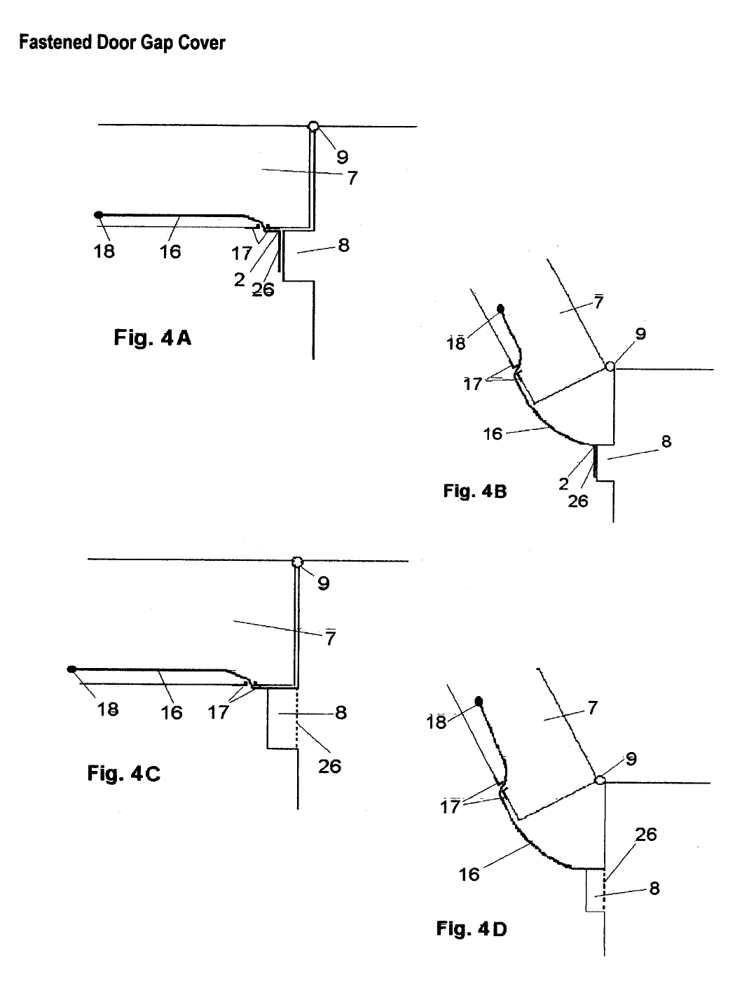

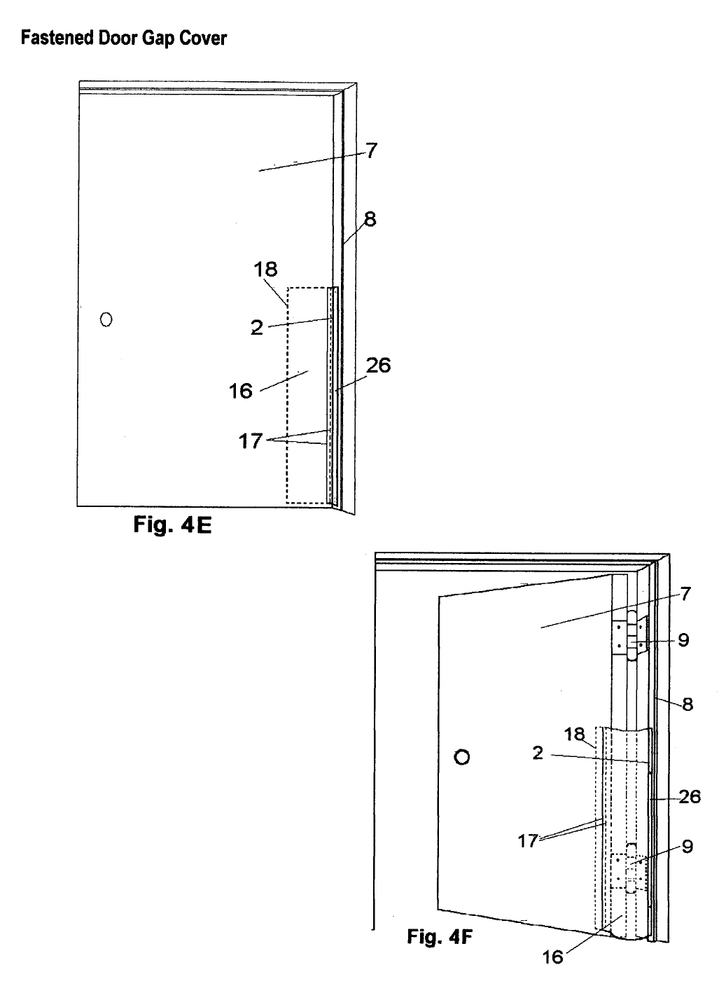

FIG. 4 shows all the parts that comprise the new construction inserted door gap cover variation of the fastened door gap cover. It shows a front perspective 16 and three upper edge views of the hinge variations 2a, 2b, 2c of the preferred embodiment of the new construction inserted door gap cover 16, together with a front view of the stop gap frame 17.

The new construction inserted door gap cover 16 is one single elongated flexible piece of material such as, but not limited to, flexible plastic of any color suitable to the door design, said colors including transparent. It has one vertical hinge line 2 and one vertical cover edge stop 18 that will be installed in the hollow portion of the door. This design is preferable for use in a hollow door however design concept can be adapted to fit solid doors as well. It also has one jamb edge 26 that will be attached to the door jamb 8 or underneath the door jamb 8 by using one or more of the following: tape, double face tape, Velcro, permanent adhesion, glue, screw, nails or any other bonding system.

The upper edge views of the new construction inserted fastened door gap cover 16 show three hinge line variations 2a, 2b, 2c. The first variation being a dual sided indentation 2a on front and back of new construction inserted door gap cover 16, the second variation being a single sided indentation 2b in the new construction inserted fastened door gap cover 16 which can be on the front or back of new construction inserted door gap cover 16 and the third variation being a supported dual sided indented flexible material 2c preferably molded as an integrated part of the new construction inserted fastened door gap cover 10 to avoid assembling requirements. The cover edge stopper 18 will be thicker or broader than the width of the opening of the stop gap frame 17. The stop gap frame 17 is a frame shaped elongated piece of rigid material such as plastic of any color suitable to the door design including transparent, and shall be slightly longer than the new construction inserted fastened door gap cover 16. The horizontal opening of the stop gap frame 17 shall be slightly wider than the new construction inserted fastened door gap cover 16 so as to allow the said cover to freely slide with door during the opening closing operation. The new construction inserted fastened door gap cover 16 would be most effective when used for the entire door height, but not limited to said height. By covering the entire height of the door the new construction inserted fastened door gap cover 16 would not only accomplish the purpose of allowing no object to be entered in the door gap opening, but would also serve to seal the air flow gap on the hinge side of door and door frame For most residential doors the new construction inserted fastened door gap cover 18 should be preferably about 4 and ¼ inches or 11 centimeters wide from the cover edge stopper 18 to the hinge line 2 and it should have a jamb edge 26 preferably about ¾ inch or 1.5 centimeters wide. For most commercial doors the new construction doors insertion door gap cover 16 should be preferably about 5 and ½ inches or 14 centimeters wide from the cover edge stopper 18 to the hinge line 2 it should have a jamb edge 26 preferably about 1 inch or 2.5 centimeters wide. The above mentioned dimensions would be suitable for most doors opening up to 110 degrees angle. For special installations where the door opens more than a 110 degree angle, a wider strip fastened door gap cover would be required accordingly.

FIG. 4A shows a bird eye view of the new construction inserted fastened door gap cover 16 with the jamb edge 26 attached to the door jamb 8 while the door 7 is in a closed position. The stop gap frame 17 is inserted in the front face of door 7 after the new construction inserted fastened door gap cover 16 is positioned inside the door. Should the door be solid, a housing incision would be included inside the door 7.

FIG. 4B shows a bird eye view of the new construction inserted fastened door gap cover 16 with the jamb edge 26 attached to the door jamb 8 while the door 7 is in an open position. The stop gap frame 17 is inserted in the front face of door 7 casing allowing the new construction doors inserted door gap cover 16 to freely slide and at the same time the stop gap frame retains the said cover inside the door 7 casing, thus allowing the new construction inserted fastened door gap cover 16 to cover the gap between the door 7 and the door jamb 8. Should the door be solid, a housing incision would be included inside the door 7.

FIG. 4C shows a bird eye view of the new construction inserted fastened door gap cover 16 with the jamb edge 26 attached underneath the door jamb 8 while the door 7 is in a closed position. The stop gap frame 17 is inserted in the front face of door 7 after the new construction inserted fastened door gap cover 16 is positioned inside the door. Should the door be solid, a housing incision would be included inside the door 7.

FIG. 4D shows a bird eye view of the new construction inserted fastened door gap cover 16 with the jamb edge 26 attached underneath the door jamb 8 while the door 7 is in an open position. The stop gap frame 17 is inserted in the front face of door 7 casing allowing the new construction doors inserted door gap cover 16 to freely slide and at the same time the stop gap frame retains the said cover inside the door 7 casing, thus allowing the new construction inserted fastened door gap cover 16 to cover the gap between the door 7 and the door jamb 8. Should the door be solid, a housing incision would be included inside the door 7.

FIG. 4E is a schematic front view of the new construction inserted fastened door gap cover 16, with its jamb edge 26 installed on the door jamb 8 while the door 7 is in a closed position. The stop gap frame 17 is inserted in the front face of door 7 after the new construction inserted fastened door gap cover 16 is positioned inside the door. Should the door be solid, a housing incision would be included inside the door 7.

FIG. 4F is a schematic front view of the new construction inserted fastened door gap cover 16 with its jamb edge 26 installed on the door jamb 8 while the door 7 is in an open position. The stop gap frame 17 is inserted in the front face of door 7 casing allowing the new construction inserted fastened door gap cover 16 to freely slide and at the same time the stop gap frame 17 retains said cover inside door 7, thus allowing the new construction inserted fastened door cover 16 to cover the gap between the door 7 and the door jamb 8. Should the door be solid, a housing incision would be included inside the door 7.

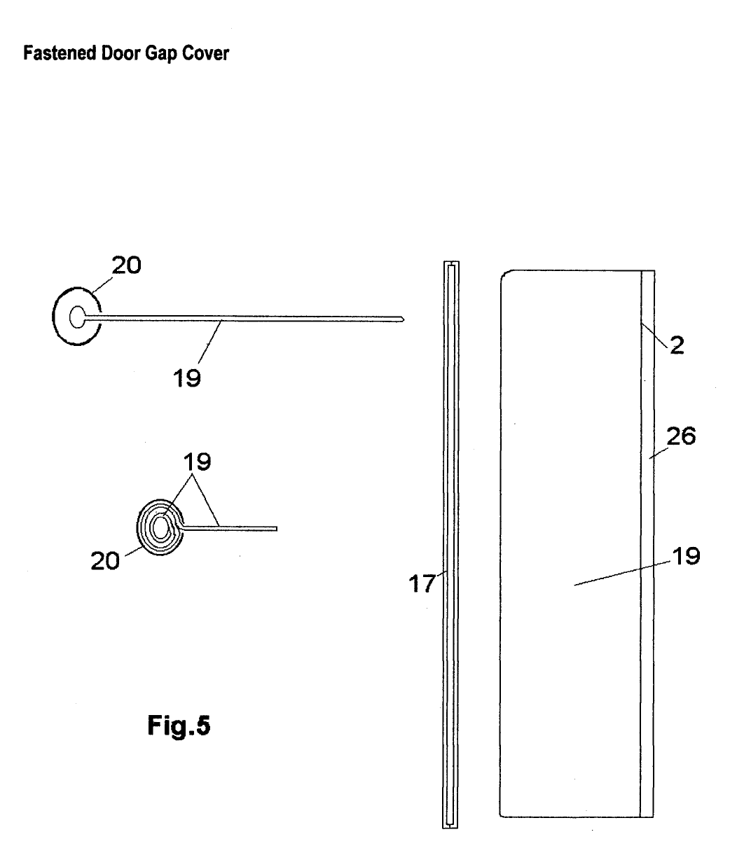

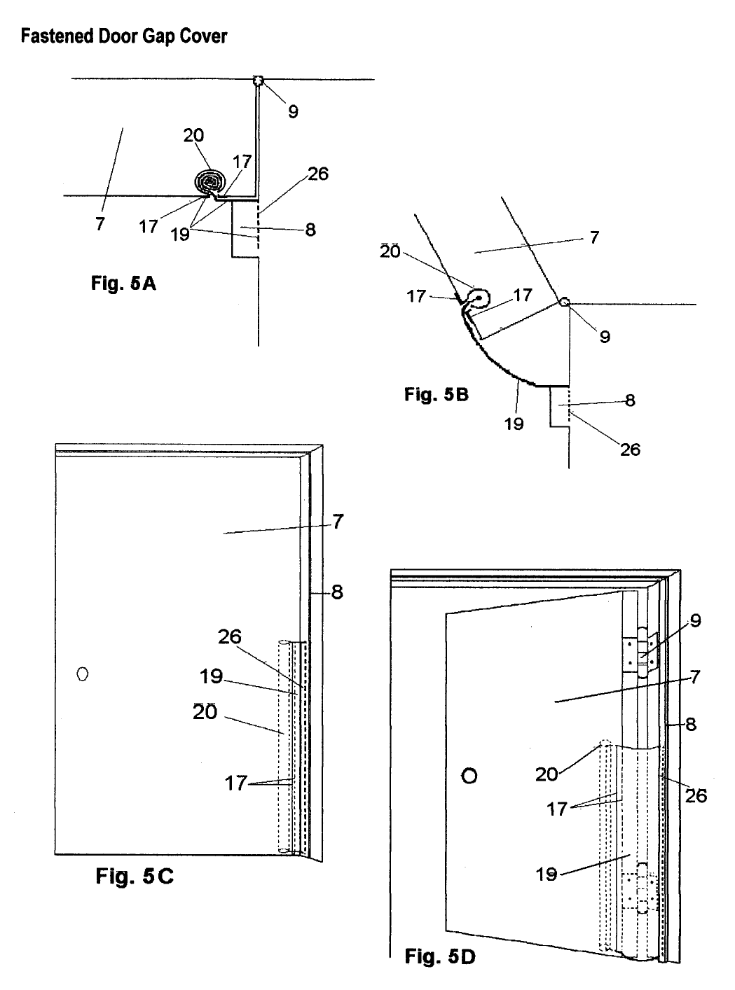

FIG. 5 shows all the parts that comprise the new construction but not limited to, roll variation of the fastened door gap cover. It shows a front and an upper edge view of the new construction roll fastened door gap cover 19 and a front view of the stop gap frame 17 and an upper edge view of the roll cover housing 20. The new construction roll fastened door gap cover 19 is a one single elongated piece made flexible material such as, but not limited to flexible plastic of any color suitable to the door design, said colors including transparent. It has one vertical hinge line 2. The new construction roll fastened door gap cover 19 will be housed by the roll cover housing 20, and preferably will utilize a spring activated tension and or a pull-back method for rolling movement of the new construction roll fastened door gap cover 19 from the roll cover housing 20 upon opening and closing of door 7. The new construction roll fastened door gap cover 19 and roll cover housing 20 would be located in the door 7 between door casings prior to the stop gap frame 17 installation in the door 7 casing. The positioning of the roll cover housing 20 and new construction roll cover fastened door gap cover would preferably located within the first two inch area, but not limited to, of the door 7 hinge edge side of the door. The positioning of the new construction roll fastened door gap cover 19 jamb edge 26 would fastened underneath the door jamb 8, but not limited to, and thereby creating a secure connection and can be secured by using one or more of the following: tape, double face tape, Velcro, permanent adhesion, glue, screw nails or any other bonding system. The upper edge views shows the new construction roll door gap cover 19 inserted into the roller cover housing 20, in both the open and closed or rolled up position.

The stop gap frame 17 is a frame shaped elongated piece of rigid material such as but not limited to rigid plastic of any color suitable to the door design including transparent, and shall be slightly longer than the new construction roll fastened door gap cover 19. The horizontal opening of the stop gap frame 17 shall be slightly wider than the new construction roll fastened door gap cover 19 so as to allow the said cover to freely slide on the door 7 during the opening closing operation. When door 7 is completely opened, the stop game frame 17 will stop or eliminate the cover from completely ejecting out of the door 7, thus allowing the gap to remain covered. The new construction roll fastened door gap cover 19 would be most effective when used for the entire door height, but not limited to said height. By covering the entire height of the door 7 the new construction roll fastened door gap cover 19 would not only accomplish the purpose of allowing no object to be entered in the door gap opening, but would also serve to seal the air flow gap on the hinge side of door and door frame For most residential doors the new construction roll fastened door gap cover 19 should be preferably about 4 and ¼ inches or 11 centimeters wide from the roll cover housing 20 to the hinge line 2 and should have a jamb edge 26 preferably about ¾ inch or 1.5 centimeters wide. For most commercial doors the new construction roll fastened door gap cover 19 should be preferably about 5 and ½ inches or 14 centimeters wide from the roll cover housing 20 to the hinge line 2 and should have a jamb edge 26 preferably about 1 inch or 2.5 centimeters wide. The above mentioned dimensions would be suitable for most doors opening up to 110 degrees angle. For special installations where the door more than a 110 degree angle, a wider new construction roll fastened door gap cover would be made accordingly.

FIG. 5A shows a bird eye view of the new construction roll fastened door gap cover 19 with the jamb edge 26 attached underneath the door jamb 8 while the door 7 is in a closed position. The stop gap frame 17 is inserted in the door 7 after the rolled cover housing 20, so as to house the new construction roll fastened door gap cover 19 inside door 7.

FIG. 5B shows a bird eye view of the new construction roll fastened door gap cover 19 with the jamb edge 26 attached underneath the door jamb 8 while the door 7 is in an open position. The stop gap frame 17 is inserted in the front of door 7 casing allowing the new construction roll fastened door gap cover 19 to freely slide and cover the gap while at the same time retain the roll cover housing 20 and the new construction roll fastened door gap cover 19 inside the door 7 during the opening and closing operation of door. Should the door be solid, a housing incision would be included inside the door 7.

FIG. 5C is a schematic front view of the entire new construction roll fastened door gap cover 19 with its jamb edge 26 installed underneath the door jamb 8 while the door 7 is in a closed position. The stop gap frame 17 is inserted in the door 7 after the rolled cover housing 20 so as to house the new construction roll fastened door gap cover 19 inside door 7. Should the door be solid, a housing incision would be included inside the door 7.

FIG. 5D is a schematic front view of the entire new construction roll fastened door gap cover 19 with its jamb edge 26 installed underneath the door jamb 8 while the door 7 is in an open position. The stop gap frame 17 is inserted in the door 7 casing allowing the new construction roll fastened door gap cover 19 to freely slide and at the same time retain the roll cover housing inside the door 7, thus allowing the new construction roll fastened door gap cover 19 to cover the gap between the door 7 and door jamb 8.

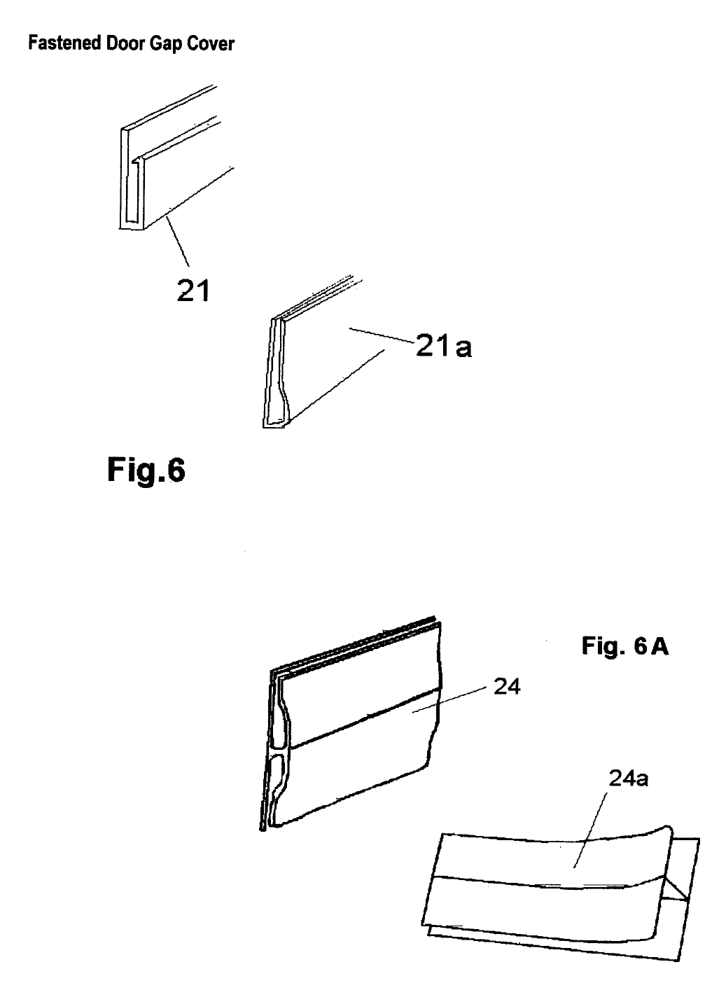

FIG. 6 is an elevated view of the single sided guide fasteners 21, 21a. Option 21 is an L shaped fastener and Option 21a is a U shaped fastener. Both fastener options can be used in conjunction with fastened door gap cover options 1, 10, 13 with use for existing door construction and the single sided fastener 21, 21a would be made of a rigid material such as but not limited to a rigid plastic of any color suitable to the door design including transparent, The single sided guide fastener 21 would be fastened to the door 7 by using one or more of the following: tape, double face tape, Velcro, permanent adhesion, glue, screw nails or any other bonding system. The fastened door gap cover options 1, 10, 13 would be inserted in the single sided fasteners at the top and bottom of the elongated one piece cover material and would freely allow covers to slide during normal opening and closing operation of the door, and at the same time cover the door gap opening.

FIG. 6A is a elevated view of the double sided guide fastener 24, 24a. Option 24 is a double sided U shaped fastener with a tightened curvature in design and Option 24a is a U shaped fastener in a straight edge design. Both fastener options 24, 24a can be used in conjunction with fastened door gap cover options 1, 10, 13 however would best be used with notched modular fastened door gap cover 27 for application to existing door construction whereas the double sided fastener 24, 24a, would be made of a rigid material such as but not limited to a rigid plastic of any color suitable to the door design including transparent, The double sided guide fastener 24, 24a would be fastened to the door 7 by using one or more of the following: tape, double face tape, Velcro, permanent adhesion, glue, screw nails or any other bonding system. The fastened door gap cover options 1, 10, 13 and 27 would be inserted in the double sided fasteners at the top and bottom of the elongated one piece cover material and would freely allow covers to slide during normal opening and closing operation of the door, and at the same time cover the door gap opening.

We claim:

1. A fastened door gap cover comprising:
an elongated piece of flexible material with a first vertical edge being hinged and connectable to a door frame or a jamb, and a parallel second vertical edge being free standing;
a fastener attachable to a door to hold said elongated piece of flexible material on the side of said parallel second vertical edge against said door while said piece of flexible material slides and covers the open gap between said door and said frame during opening and closing operation of said door.

2. A fastened door gap cover as in claim 1, wherein said fastener is an elongated piece of rigid material, whereas the length of fastener extends beyond the top and bottom of the said elongated piece of flexible material covering the gap

3. A fastened door gap cover as in claim 1, wherein said elongated piece of flexible material has horizontal slots, wherein said fastener is a screw, pin or bolt with a head larger then the vertical opening of said horizontal slots.

4. A fastened door gap cover as in claim 1, wherein said elongated piece of flexible material has horizontal slots and wherein said fastener is a screw, pin or bolt coupled with a base plate and said fastener has a head larger than the vertical opening of said horizontal slots.

5. A fastened door gap cover as in claim 1, wherein said elongated piece of flexible material has a notch or notches on said cover for purpose of aligning multiple said covers together.

6. A fastened door gap cover as in claim 1, wherein said elongated piece of flexible material has a horizontal male protrusion on its undersurface and said fastener is a coupling horizontal female channel.

7. A fastened door gap cover as in claim 1, wherein said elongated piece of flexible material has a horizontal female channel on its undersurface and said fastener is a coupling horizontal male protrusion.

8. A fastened door gap cover as in claim 1, wherein said fastener is a single routed L shaped or U shaped guide.

9. A fastened door gap cover as in claim 1, wherein said fastener is a reversed double routed L shaped or U shaped guide.

10. An inserted door gap cover as in claim 1, wherein the said first vertical edge is attached above or underneath door frame or door jamb.

11. An inserted door gap cover comprising:
an elongated piece of flexible material with a first vertical edge being hinged and connectable to a door frame or a jamb, and a parallel second vertical edge being free standing;
a vertical incision housing in the front of a door to house said elongated piece of flexible material and retain said piece of flexible material inside said door while said piece of flexible material slides and covers a gap between said door and said door frame during opening and closing operation of said door.

12. An inserted door gap cover as in claim 11, wherein said parallel second vertical edge is broader in design than the remainder of said elongated piece of flexible material.

13. An inserted door gap cover as in claim 11, wherein a frame is attached to a door surface in conjunction with said vertical incision housing in order to define said vertical incision housing and eliminate ejection of said elongated piece of flexible material from said door.

14. An inserted door gap cover as in claim 11, wherein an elongated rolling device is used to roll in and out said elongated piece of flexible material inside said incision housing.

15. An inserted door gap cover as in claim 11, wherein the said first vertical edge is attached above or underneath door frame or door jamb.
